(19) United States
(12) Patent Application Publication
(10) Pub. No.: US 2020/0182038 A1
(43) Pub. Date: Jun. 11, 2020

(54) HIGH-SPEED ANALYTICS AND VIRTUALIZATION ENGINE

(71) Applicant: National Oilwell Varco, L.P., Houston, TX (US)

(72) Inventors: Ian Michael Soukup, Austin, TX (US); Jacob Christian Peterson, Austin, TX (US); Ricardo Ramirez, Cedar Park, TX (US)

(21) Appl. No.: 16/215,012

(22) Filed: Dec. 10, 2018

(51) Int. Cl. E21B 44/04; G01V 99/00; E21B 41/00

(52) U.S. Cl. CPC E21B 44/04; E21B 41/0092; G01V 99/005

(57) ABSTRACT

Techniques related to improving performance of an automated control system for drilling with a drilling system, comprising directing drilling tools on a drilling rig to drill, a borehole using the automated control system, obtaining, from one or more surface sensors disposed at a surface of the drilling site, surface sensor data relating to surface drilling activity of the drilling system, determining, based on a comparison between the surface sensor data and a set of historical data, a set of drilling parameters associated with a drilling state, applying the set of drilling parameters to a physics model of the drilling site to determine a set of downhole parameters for the drilling site, wherein the physics model comprises a simulation of current conditions of the borehole and a drill string of the drilling rig, and adjusting operation of at least one of the drilling tools based on the set of downhole parameters.

### BACKGROUND ART

Embodiments described herein generally relate to automated drilling, and more specifically to optimizing performance of an automated control system for drilling.

Oilfield operations may be performed to locate and gather valuable downhole fluids. Oil rigs are positioned at wellsites, and downhole tools, such as drilling tools and other components, are deployed into the ground to reach subsurface reservoirs. Traditionally, human operators will need to press dozens of buttons in order to operate rig equipment to complete the drilling process. In addition, although a human operator may be relying on feedback provided by the downhole tools, drilling operations controlled by human operation may lack consistency, or may be subject to human error. Further, while some drilling applications allow for a software-based management of drilling operations, they often require the application developer to be keenly aware of the particulars of a rig, such as specific tools, and language needed to drive those tools. Thus, an automated control system for drilling is preferred. However, an automated control system may be slow compared to manual operation of the drilling rig. A method of optimizing an automated control system is needed.

### SUMMARY

This disclosure relates generally to automated drilling. More particularly, but not by way of limitation, aspects of the present disclosure relate to a method for improving performance of an automated control system for drilling with a drilling system at a drilling site. The method includes directing drilling tools on a drilling rig to drill, at the drilling site, a borehole using the automated control system by obtaining, from one or more surface sensors disposed at a surface of the drilling site, surface sensor data relating to surface drilling activity of the drilling system. The method further includes determining, based on a comparison between the surface sensor data and a set of historical data, a set of drilling parameters associated with a drilling state. The method also includes applying the set of drilling parameters to a physics model of the drilling site to determine a set of downhole parameters for the drilling site, wherein the physics model comprises a simulation of current conditions of the borehole and a drill string of the drilling rig. The method further includes adjusting operation of at least one of the drilling tools based on the set of downhole parameters.

Another aspect of the present disclosure relates to a system for improving performance of an automated control system for drilling with a drilling system at a drilling site. The system comprises one or more drilling tools on a drilling rig to drill, at the drilling site, a borehole using the automated control system, one or more sensors disposed at a surface of the drilling site, and the automated control system. The automated control system includes one or more processors and a non-transitory program storage device comprising instructions stored thereon. The non-transitory program storage device comprising instructions stored thereon to cause the one or more processors to obtain, from the one or more surface sensors disposed at a surface of the drilling site, surface sensor data relating to surface drilling activity of the drilling system. The instructions further cause the one or more processors to determine, based on a comparison between the sensor data and a set of historical data, a set of drilling parameters associated with a drilling state. The instructions further cause the one or more processors to apply the set of drilling parameters to a physics model of the drilling site to determine a set of downhole parameters for the drilling site, wherein the physics model comprises a simulation of current conditions of the borehole and a drill string of the drilling rig. The instructions further cause the one or more processors to adjust the operation of at least one of the drilling tools based on the set of downhole parameters.

Another aspect of the present disclosure relates to a non-transitory program storage device for drilling with a drilling system at a drilling site comprising instructions stored thereon. The instructions cause one or more processors to direct drilling tools on a drilling rig to drill, at the drilling site, a borehole using the automated control system. The instructions further cause one or more processors to obtain, from one or more surface sensors disposed at a surface of the drilling site, surface sensor data relating to surface drilling activity of the drilling system. The instructions also cause one or more processors to determine, based on a comparison between the surface sensor data and a set of historical data, a set of drilling parameters associated with a drilling state. The instructions further cause one or more processors to apply the set of drilling parameters to a physics model of the drilling site to determine a set of downhole parameters for the drilling site, wherein the physics model comprises a simulation of current conditions of the borehole and a drill string of the drilling rig. The instructions also cause one or more processors to adjust operation of at least one the drilling tools based on the set of downhole parameters.

### BRIEF DESCRIPTION OF DRAWINGS

FIG. 1 is a diagram illustrating an apparatus for performing automated drilling operations utilizing a drilling rig software system.

FIG. 2 is a system diagram illustrating a drilling rig software system for automated drilling, including an optimization module.

FIG. 3 is a flow diagram illustrating components of a rig computing system, in accordance with aspects of the present disclosure.

FIG. 4 is a system diagram illustrating components of components of a rig computing system, in accordance with aspects of the present disclosure.

FIG. 5 is a chart illustrating torque and angular velocity responses of the drill string, in accordance with aspects of the present disclosure.

FIG. 6 is a flowchart illustrating a technique for optimizing performance of an automated control system for drilling, in accordance with aspects of the present disclosure.

FIG. 7 is a block diagram illustrating a rig computing device for use with techniques described herein, in accordance with aspects of the present disclosure.

### DESCRIPTION OF EMBODIMENTS

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of automated drilling having the benefit of this disclosure.

As used herein, the term “programmable device” can refer to a single programmable device or a plurality of programmable devices working together to perform the function described as being performed on or by the programmable device.

As used herein, the term “medium” refers to a single physical medium or a plurality of media that together store what is described as being stored on the medium.

As used herein, the term “network device” can refer to any programmable device that is capable of communicating with another programmable device across any type of network.

As used herein, the term “drilling rig” can refer to a land or offshore rig apparatus utilized to drill a borehole.

As used herein, the term “drilling tool” can refer to drilling components such as drilling devices or sensors utilized to perform drilling activities.

The performance of an automated control system for drilling may generally be optimized in conjunction with computational models of a drilling site. Examples of computational models include a data model and a physics model.

Physics models generally employ mathematical descriptions to simulate physical systems in order to make predictions. Examples of physics models include lumped parameter, neural-type time-delay, distributed parameter, and finite element method models. However, drilling system complexities and unknown parameters for a physics model, such as those related to subsurface formation integrity and characteristics can decrease the accuracy of physics models. Extensive parameter calibration can help increase accuracy, but such calibration may be costly. Additionally, physics models having significant degrees of freedom modelling may require substantial computing power. In certain cases, cloud computing has been used to address the computing power issue, but this approach tends to be difficult to perform in real-time due to the remote locations, including off-shore locations, of many drilling sites. Additionally, cloud computing solutions tend to introduce additional latency issues, along with difficulties associated with consistently obtaining sufficient network capacity for both sensor data uplink and computed result downlink.

Generally, a data model attempts to make predictions about characteristics of the drilling rig and borehole based on correlational and statistical analysis. For example, the data model may compare sensor data obtained from the drilling site to historic sensor data using adaptive algorithms, such as statistical algorithms or machine learning systems, to predict the status of the drilling process. Data models generally do not recognize the underlying physical principles acting on the drilling site. Typically, data model accuracy can depend greatly on the data set as well as sensor data available to the data model. Data models which rely on just surface sensors typically suffer from issues in which certain physical phenomena are either not projected to the surface, or present as subtle magnitudes that are not measurable with the resolution of current surface sensors. Data models which utilize sensor data from downhole sensors typically are costlier, both from a sensor perspective and because downhole sensors data sets can be difficult and expensive to obtain. Additionally, data models relying on downhole sensors can be affected by latency issues resulting from the amount of time required to obtain downhole sensor data from sensors which may be well over a mile away.

Generally, a drilling site, including drilling rig, borehole, and surrounding areas, can include multiple sensors. Some or all of the drilling tools may include sensors which may be utilized to obtain sensor data. The sensor data may be used to determine properties of the drilling process or a status of the drilling process. These sensors may be generally located on or around the ground surface level, as well as located below the surface, such as along or at the bottom of the drill string. However, subsurface or downhole sensors tend to be costlier and add increased complexity as downhole sensors are typically subject to harsh working conditions as well as challenges associated with passing sensor readings to the surface which may be miles away. In many cases, drilling sites will use only surface sensors as surface sensors tend to be more cost efficient than downhole sensors.

According to one or more embodiments, the performance of an automated control system for drilling may be optimized utilizing two or more linked computing models of a drilling site to predict downhole and along-string phenomena based on data provided by surface sensors. As an example of the linked computational models, a data model may utilize sensor data and provide information for a physics model to predict downhole drilling parameters in real time (e.g., <20-50 ms). In certain cases, the data model uses the sensor data to generate a set of drilling parameter values, such as values for downhole weight on bit, downhole torque on bit, downhole revolutions per minute, and downhole drilled distance. These predictions may be output from the data model and input into a physics-based model to generate a predicted set of downhole drilling parameters. In one or more embodiments, output from the linked computing models may be used to monitor or automate the drilling process, for example, by adjusting drilling activity based on the predicted set of downhole drilling parameters or triggering another drilling activity based on the predictions.

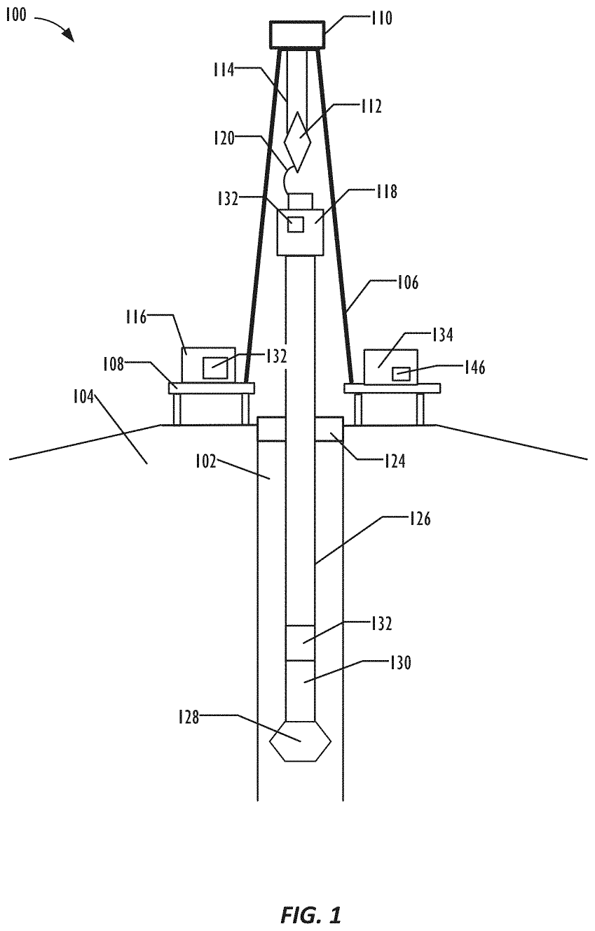

In one embodiment of the invention, as illustrated in FIG. 1, an apparatus 100 for automated drilling of a borehole 102 in a subsurface formation 104 includes a derrick 106 on a rig floor 108. A crown block 110 is mounted at the top of the derrick 106, and a traveling block 112 hangs from the crown block 110 by means of a cable or drilling line 114. One end of the cable or drilling line 114 is connected to drawworks 116, which is a reeling device operable to adjust the length of the cable or drilling line 114 so that the traveling block 112 moves up and down the derrick 106. A top drive 118 is supported on a hook 120 attached to the bottom of the traveling block 112. The top drive 118 is coupled to the top of a drill string, which extends through a wellhead 124 into the borehole 102 below the rig floor 108. The top drive 118 is used to rotate the drill string inside the borehole 102 as the borehole 102 is being drilled in the subsurface formation 104. A bottomhole assembly 126 is provided at the bottom of the drill string. The bottomhole assembly 126 includes a bit 128 and a downhole motor 130 and may include other components not specifically identified but known in the art, e.g., a sensor package.

Although not shown, the automated drilling apparatus 100 includes a mud tank, which contains drilling fluid or “mud,” a mud pump for transferring the drilling fluid to a mud hose, and a mud treatment system for cleaning the drilling fluid when it is laden with subsurface formation cuttings. The mud hose, in use, would be fluidly connected to the drill string so that the drilling fluid can be pumped from the mud tank into the drill string. The drilling fluid would be returned to the mud treatment system via a return path between the borehole and the drill string or inside the drill string, i.e., if the drill string is a dual-bore drill string. After the drilling fluid is cleaned in the mud treatment system, the clean drilling fluid would be returned to the mud tank.

In one embodiment of the invention, the automated drilling apparatus 100 includes sensors (or instruments) 132 for measuring drilling data. A variety of drilling data may be measured by the sensors 132. The locations of the sensors in the automated drilling apparatus 100 and the types of sensors 132 will be determined by the drilling data to be measured by the sensors 132. Examples of drilling data that may be measured by the sensors 132 include, but are not limited to, surface weight on bit, surface drill string rotational speed, surface drill string rotational torque, rate of penetration, bit diameter, and drilling fluid flow rate. Measuring of drilling data may be direct or indirect. In the indirect measurement, the desired drilling data may be derived from other measurable drilling data. The drilling data may be measured at the surface and/or in the borehole. For example, drill string rotational torque may be measured at the surface using a sensor 132 on the top drive 118. Alternatively, pressure differential across the downhole motor 130 may be measured using a sensor 132 downhole. In another example, the load on hook 120 may be measured using any suitable means at the surface, and weight on bit may be inferred from the hook load. Various other drilling data not specifically mentioned above may be measured, or derived, as required by the drilling process.

In one embodiment, the drilling apparatus 100 includes one or more rig computing systems, such as rig computing system 134. In one embodiment, the rig computing system 134 includes various computing components and peripherals, such as a processor, memory, a display, a communications interface, and an input interface 144. The rig computing system 134 can receive measurement of drilling data from the various sensors 132 of the automated drilling apparatus 100. Information related to operation of the rig computing system 134 may be stored in some other computer-readable media 146 for subsequent loading into memory. Although the rig computing system 134 is shown primarily at the surface in FIG. 1, it should be noted that in other embodiments of the invention a portion or all of the rig computing system 134 may be located downhole.

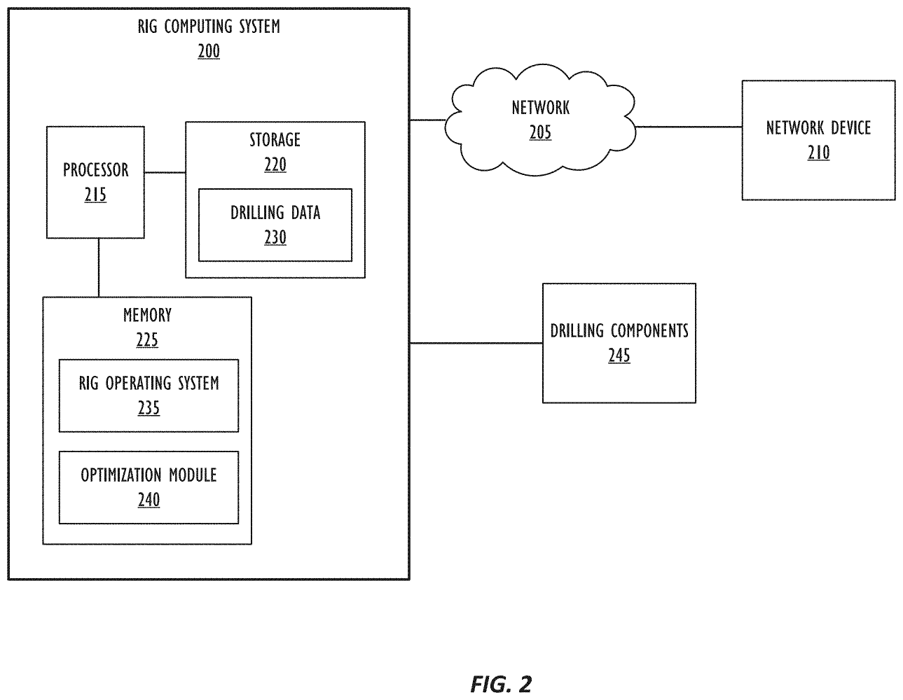

FIG. 2 depicts a system diagram illustrating a drilling rig software system for automated drilling. FIG. 2 includes a rig computing system 200 connected to one or more network devices 210 across a network 205. Rig computing system 200 may be, for example, a detailed version of rig computing system 134 of FIG. 1. Network device 210 may include any kind of device accessible across network 205, with which rig computing system 200 may communicate. For example, network device 210 may be an additional rig computing system, a server, a remote computer, or the like. Network 205 may include many different types of computer networks available today, such as the Internet, a corporate network, a Local Area Network (LAN), or a personal network, such as those over a Bluetooth connection. Each of these networks can contain wired or wireless programmable devices and operate using any number of network protocols (e.g., TCP/IP). Network 205 may be connected to gateways and routers, servers, and end user computers.

According to one or more embodiments, rig computing system 200 may include, for example, a storage 220, a memory 225 and processor 215. Processor 215 may include a single processor or multiple processors. Further, in one or more embodiment, processor 215 may include different kinds of processors, such as a central processing unit (“CPU”) and a graphics processing unit (“GPU”). Memory 225 may include a number of software or firmware modules executable by processor 215. Memory 225 may include a single memory device or multiple memory devices. As depicted, memory 225 may include a rig operating system 235 and optimization module 240. The rig operating system 235 may be a process automation platform that manages rig equipment to execute optimization module 240's generation of an analytics model. In one or more embodiment, the rig operating system 235 may receive instructions from the optimization module 240 and coordinate the instructions with the drilling components 245 to implement the well plan. The well plan may include a set of event-driven drilling activities that make up one or more drilling processes. In one or more embodiments, the optimization module 240 may be utilized to optimize the drilling processes.

In one or more embodiments, the optimization module 240 may monitor and manage drilling activities in order to deploy a well plan. The drilling activities may include event-driven activities, such that the rig operating system 235 may utilize data generated and/or received from the optimization module 240 to monitor drilling data for events that trigger a next drilling activities in the drilling process. The rig operating system 235 may initially utilize default or provided drilling parameters in order to deploy the various drilling activities in a drilling process. While the drilling activities are performed, the optimization module 240 may monitor drilling data, such as data from sensors of drilling components 245. The optimization module 240 may utilize the drilling data to identify trigger signatures which may better identify an event that triggers a next drilling activity in a drilling process. The drilling data may be inputted to the optimization module 240, either as raw data from the sensors of drilling component 245, as processed data after prior processing, for example, by the rig operating system 235, or a mixture of raw and processed data.

According to one or more embodiments, the optimization module 240 may manage performance of the rig by tracking actions directed by the rig computing system 200, and responses by the system. As an example, if the rig computing system 200 directs a change in RPMs, a detected change in torque would be expected. Similarly, a change in flow would result in an expected change in pressure. According to one or more embodiments, the change in torque or pressure may be monitored by sensor data from drilling components 245 implementing the well plan, such as the top drive. The signal data from the sensors may be analyzed in order to identify a trigger signature that indicates a particular drilling activity should be initiated. In one or more embodiments, the analysis may be performed by the optimization module 240 utilizing multiple computational models of the borehole and drilling rig. The result is that the optimization module 240 may generate an adaptive model which identifies trigger signatures that may be more accurate in deploying a well plan that utilizing default drilling parameters, such as thresholds. As an example, a default drilling parameter may indicate that a motor stall is detected if, in part, a torque measurement increases at a particularly aggressive rate, or if the torque measurements satisfies a threshold. According to one or more embodiments, the optimization module 240 may determine a trigger signature based in part on a particular pattern in the sensor data during a particular time. Thus, for example, if the sensor data from the top drive never indicates that the torque satisfies a threshold measurement or acceleration, then the motor stall may not be detected, whereas by identifying a trigger signature in the top drive sensor data, a particular signature in the signal data may better identify a potential motor stall, thus allowing the system to employ mitigating or corrective action.

The optimization module 240 may receive the data through the rig operating system 235, or may be part of the rig operating system 235. In one or more embodiments, the optimization module may receive the data directly from one or more of the drilling components 245. In one or more embodiments, the optimization module 240 may use historic drilling data for a particular well, type of well, customer, or the like. Historic drilling data may be stored, for example, in storage 220 as part of drilling data 230. As described in more detail below, historic drilling data may be analyzed and compared to data received directly or indirectly from the drilling components 245 and used to determine a state in which the current drilling process is in, event occurrences, etc., using a data model. By analyzing historic drilling data, the optimization module may determine an expected signature for a particular event. Historic and current drilling data may be stored locally in storage 220 as drilling data 230. Alternatively, or additionally, drilling data and historic data may be stored in network storage, such as network device 210 across network 205. Although the various components are depicted within a single computing device rig computing system 200, in one or more embodiments, the various components and functionalities described with respect to the rig computing system 200 may instead be reconfigured in a different combination, or may be distributed among multiple computing devices.

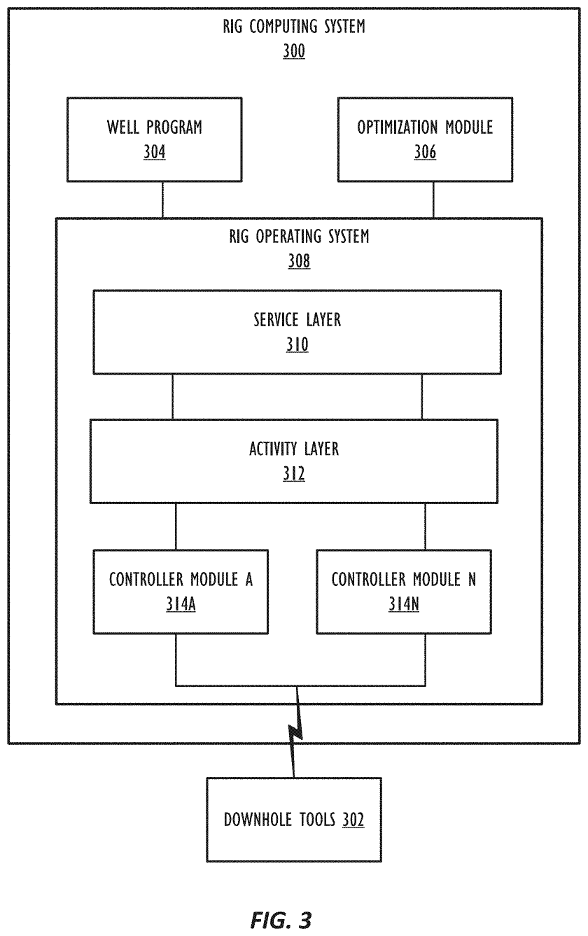

Turning to FIG. 3, a system diagram illustrating components of a rig computing system. Specifically, FIG. 3 provides a schematic of an example data flow within the rig computing system 300. The rig computing system 300 may include optimization module 306, and a rig operating system 308. In addition, the rig computing system 300 may include a well program 304, which may facilitate management of the rig. The rig operating system may include several layers in which data flows. The rig operating system 308 may receive instructions from the optimization module 306. The optimization module 306 may provide tool-agnostic instructions. That is, optimization module 306 may be written for generic drilling components, and the rig operating system 308 may translate the tool-agnostic instructions provided by the optimization module 306 into tool-specific instructions, to direct the specific downhole tools 302 accessible by the rig computing system 300. In one or more embodiments, multiple drilling applications, such has well program 304 and optimization module 306 may be utilized during drilling. The drilling applications may be managed by different entities, such as unique operators, contractors, owners, and the like. Thus, a first activity for a sub-process may be directed by a first application and managed by a first entity, whereas a second activity for the sub-process may be directed by a second application managed by a second entity. According to one or more embodiments, the rig computing system may toggle between utilizing the various drilling applications. Further, in one or more embodiment, drilling data generated while a particular entity is controlling an activity may be partitioned into a separate storage from drilling data generated while another entity is controlling an activity. The separate storage may be, for example, a separate physical storage device, a storage partition in a physical storage device, or a different data structure on a storage device. Thus, ownership of an activity may be managed for example, based on depth, formation, or section of a well plan.

The rig operating system 308 may include multiple components or layers that are utilized to translate tool-agnostic well plans into tool-specific instructions to direct downhole tools 302 to implement the well plan. In one or more embodiments, the rig operating system 308 may include a service layer 310, an activity layer 312, and a set of controller modules 314. In one or more embodiments, the service layer 310 may coordinate with a tool-agnostic request to an activity layer. The service layer may identify one or more activities required to complete a requested service or sub-process. As an example, the service layer 310 may receive instructions from a drilling application with instructions to perform a drill function to a particular depth, or in a particular formation. The service layer 310 may manage the activities needed to perform the different sub-process functions required to achieve the objective from a current drilling state. In one or more embodiments, the service layer 310 may switch between processes or objectives manually based on user input, or dynamically based on a predefined well plan or other instructions provided by an optimization module 306 or well program 304. Further, in one or more embodiments, the process may be dynamically modified based on a model or algorithm input. For example, the service layer 310 may switch the process objective from drilling to tripping or to reaming based on the input.

The service layer 310 may coordinate with the activity layer 312 to manage the various activities required to complete the requested sub-process or service. The activity layer may coordinate with one or more controller modules 314 to implement a particular activity. As an example, the activity layer 312 may identify various controller modules required to implement an activity as directed by the service layer 310. Further, according to one or more embodiments, the activity layer 312 may determine whether one or more controller modules 314 are available for performing a necessary activity. In one or more embodiments, if a controller module 314 is not available, then the activity layer 312 may trigger a notification such that the particular activity may be driven by a user.

According to one or more embodiments, the controller modules 314 act as an abstraction layer that allows optimization module 306 to be tool-agnostic, and controller module 314 to translate the instructions for specific downhole tools 302 or other drilling components. In one or more embodiments, controller modules 314 may include state machine logic to start and stop downhole tools 302 and controller modules 314 may be tool-specific. That is, a controller module may be associated other components, and bridge the process to the machine. The controller modules 314 may translate tool-agnostic instructions into tool-specific instructions based on the specific downhole tools 302 or other components available on a rig, thereby driving the tools. In one or more embodiments, the with a particular tool or tools such that the controller module generates tool-specific instructions for that particular tool. Further, in one or more embodiments, the controller modules 314 may be associated with multiple tools or components, or may be associated with a particular function of a particular tool. As an example, the top drive 118 may be utilized for sub-processes or activities such as circulation, rotation, and pipe handling. Each of circulation, rotation, and pipe handling may be managed by a separate controller module 314. The controller module 314 associated with a particular tool may drive that tool to implement actions to perform the activity. Further, according to one or more embodiments, controller modules 314 may be associated with particular functionality. For example, one or more controller modules 314 may be associated with rotation, whereas another one or more controller modules 314 may be associated with circulation. In this example, each controller module 314 may be associated with a particular set of drilling components based on functionality, and may include the capability to translate tool-agnostic instructions into tool-specific instructions for tools associated with the particular functionality.

According to one or more embodiments, the service layer 310 may manage the scheduling of the various sub-processes by the activity layer 312 and the controller modules 314. For example, the service layer may determine a current drilling state and, based on the drilling state, trigger the activity layer 312, and thus the controller modules 314 to perform an action. For example, if the objective is to drill, the controller modules 314 may initiate pumps to prepare for a particular flow, initiate a top drive for a particular circulation, and the like.

In addition, the service layer 310 may manage the optimization module 306 from which instructions are received. The service layer 310 may toggle between reference performance indexes used in optimization module 306 based on a drilling state. A drilling state may be determined based on sensor data from sensors 132. The drilling state may include contextual data either from or determined based on data from the sensors 132, or environmental contextual data, such as drilling depth. For example, a first reference performance index may be used in optimization module 306 until the drilling operation reaches a particular depth, at which point a second reference performance index may be used in optimization module 306 instead. Thus, the service layer 310 may monitor a current depth or other drilling state information, and toggle between the various reference performance indexes in use in optimization module 306 accordingly.

Further, in one or more embodiments, the well program 304 may monitor various drilling measurements to ensure that the various drilling components perform within certain thresholds. As an example, thresholds may determine safe operation of the components, or may be utilized for resource management, such as power savings, or to limit wear and tear on machinery. According to one or more embodiments, the thresholds may be set by the well program 304 or optimization module 306. The thresholds may be set based on various drilling parameters, such as drilling state (i.e., a current activity, a current depth, or other contextual information). In one or more embodiments, when a threshold is exceeded, the well program 304 may modify the sub-process or activity directed by optimization module 306 such that the drilling parameter remains within a certain threshold.

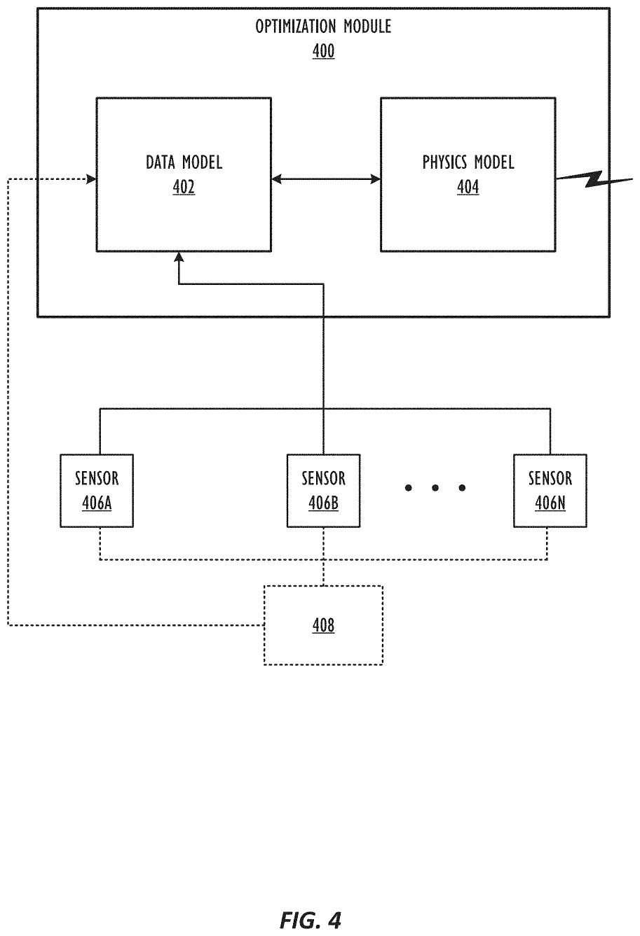

FIG. 4 is a system diagram illustrating components of components of a rig computing system, in accordance with aspects of the present disclosure. More specifically, FIG. 4 provides a schematic of an example of certain data flows with respect to an optimization module 400. The optimization module 400 includes, among other components, a data model 402 and a physics model 404. While the optimization module 400 is shown as a single module, it is understood that in one or more embodiments the optimization module may be implemented using one device, multiple devices, or virtualized devices. For example, the data model 402 may be implemented on a separate device than the physics model 404.

The data model 402 is configured to receive sensor data from one or more sensors 406A-406N. In certain cases, sensors 406A-406N may comprise surface sensors. Data from the sensors 406A-406N may be provided via a management system, such as rig operating system (not shown). In other cases, sensor data may be obtained as raw data from the sensors 406A-406N, or via control system 408 which integrates with the sensors 406A-406N, but separate from the rig operating system (not shown). Surface sensor data may include information related to surface drilling activity, such as surface mud flow rate, surface torque, surface RPM, and surface weight. In certain cases, the sensors 406A-406N may be configured to provide sensor data at relatively high frequencies as compared to typical surface sensors, such as 200 hertz or higher.

The data model 402 compares received sensor data to a historical set of sensor data. The historical set of data may be based on sensor data from the well being drilled, other similar wells, other wells generally, and may also include synthesized sensor data. The comparison may be based on, in one or more embodiments, a statistical analysis between the sensor data and the historical set of sensor data. In certain embodiments, a machine learning model may be trained on the historical set of sensor data and the received sensor data may be run through the trained machine learning model. Certain embodiments may employ multiple approaches, for example, combining statistical and machine learning algorithms. In one or more embodiments, the multiple data models may be available and a particular data model may be identified based on contextual conditions of the current well, such as knowledge about formation, geographic area, and the like. In one or more embodiments, the data model may be obtained from the storage 220, or the network device 210. Further, the data model may be provided by the rig computing system 200 without any well-specific data or may be partially trained based on historic data.

In one or more embodiments, the data model may be tuned to address limitations of the physics model. For example, the data model may be tuned to provide predictions of specific drilling parameters for use by the physics model 404. This tuning may help improve predictive accuracy of the data model 402 as compared to more general-purpose data models as the data model 402 can be focused toward those drilling parameters. These drilling parameters may be selected to help characterize physical parameters that are generally unknown by the physics model. In certain embodiments, the drilling parameters can include, but are not limited to whether the drill string is rotating and circulating off-bottom (e.g., the drill bit is not in contact with the formation), whether the drill string is on-bottom (e.g., the drill bit is in contact with the formation) and drilling, surface position, that pipe is being added, and/or how much pipe is being added on the string. Generally, surface position indicates how much of a particular pipe has been pushed down a derrick and/or a speed at which the pipe is being pushed down the derrick. The drilling parameters may then be provided to the physics model 404 on an ongoing basis as sensor data is received by the data model 402. In one or more cases, the drilling parameters may be provided to the physics model at the same or substantially the same data rate that sensor data is provided to the data model.

In accordance with certain aspects of the present disclosure, the physics model 404 comprises a simulation of current conditions of the borehole and drill string, mathematically modeling the drilling system, taking into consideration the physical forces interacting between both the drill string and borehole. The physics model 404 may be configured to receive drilling parameters from the data model 402 to help address limitations of the physics model 404. For example, properties for each element, such as mass, stiffness, and damping, may vary based on the physical state of the modeled system. Recalculation of one or more elements of the physics model to take into account certain changes may be triggered based on certain drilling parameters, such as surface position, or an indication that pipe has been added to the drill string. For example, adding pipe to a drill string changes, among other properties, the length and mass of the drill string and elements of a finite element method model may need to be redefined to take these changes into account. Similarly, information related to whether the drill string is off-bottom and is rotating (for example, if the drill string breaks into a cavity) can be taken into account by the physics model 404. Based on the drilling parameters provided by the data model, the physics model can more accurately simulate and characterize the drilling site as compared to using a data model alone. For example, predicting downhole boundary conditions using just a data model absent downhole sensors can be difficult due to limitations related to surface sensor sensitivity. The physics model 404 helps address these difficulties by mathematically characterizing and simulating the drill site to help predict downhole boundary conditions. According to certain aspects of the present disclosure, the physics model 404 may calculate and output information related to boundary conditions including, but not limited to downhole weight on bit, downhole torque on bit, downhole revolutions per minute, and downhole drilled distance (DDD).

While many different physics models may be used, in certain embodiments, the physics model 404 may comprise a fine element method (FEM) model. The finite element method divides a drill site into multiple smaller, simpler elements and models each element. For example, a finite element method representation of a drill string may split the string into multiple elements of a certain length. In certain cases, each element may represent unequal lengths of the drill string. For example, a particular element representing a curving portion of the drill string may represent a shorter length than another element representing a largely straight portion. The elements may be assembled to model the entire drill site by integrating across each element to solve for forces acting on each element.

In one or more embodiments, the drill string may be modeled by the FEM by numerous elements such that the defining equations of motion with boundary conditions and applied forces are more easily described. When written in matrix form, these ordinary differential equations (ODEs) are called local matrices, and with FEM, they are combined to form a global matrix form ODE [Mᵢ]{ëᵢ}+\dot{Ω}[Gᵢ]{ėᵢ}+[Kᵢ]{eᵢ}={Qᵢ} where Mᵢ, Gᵢ, and Kᵢ are 12×12 local mass, gyroscopic, and stiffness matrices of the i^{th} element and {eᵢ} is the deformation vector. Numerical integration of the global ODE calculates the physical states or degree of freedom (DOF) at each node. In one or more embodiments, for the physics model 404, six physical states may be defined for each node, 12 for each element, which describe three axial motions and three rotational motions.

In certain embodiments, the physics 404 model may include multiple applied forcing functions such as fluid interaction forces, sidewall forces, and bit formation contact forces and accurate boundary conditions help increase accuracy of the forcing functions. The physics model 404 may be configured based on expected well bore geometry obtained from well plans and sensor data can provide the spatial orientation of the drill string. When combined with the drill string component (including the bottomhole assembly (BHA)) geometry and material properties, accurate normal forces and points of wellbore contact may be calculated.

In accordance with certain aspects, well bore forces may consist of several forces. These forces include an impact force, stiffness force, friction force, and resistive torque. Impact force from the drill string may be calculated based on the drill string velocity at contact based on the equation F_{impact}=m(Δv/Δt). Stiffness force due to small penetration of the pipe into the well bore may be calculated based on the equation F_{stiffness}=KΔx. Friction force may be calculated based on impact force and stiffness using the equation F_{μ}=μ(F_{impact}+F_{stiffness}). Resistive torque may be calculated using the equation T=F_{μ}×Rₚᵢₚₑ.

In accordance with certain aspects, fluid forces may be extracted from extracted from computational fluid dynamics relationships described by fitted curves. Numerical integration may be used to solve the definite integrals of a slice through the well bore defining the fluid dynamic drag forces as a function of relative position of a discrete drill string section in the wellbore. Generally, a mud annulus is between walls of the wellbore and the drill string. Assuming that the borehole mud velocity is zero, as it is moving with the drill string velocity at their contact, the shear stress exerted to the drill string due to its rotation in mud may be described as τ=μV/h(γ), where h(γ) is the distance between drill string and borehole at different angles, which is computed based on the equation h(γ)=\sqrt{R_{well}²−(eᵢ sin γ)²}−eᵢ cos γ−Rₚᵢₚₑ. After integrating the shear stress along the normal and tangent axis (n and t axis), the normal component of the force is cancelled due to the symmetry, and the tangent component of the force and mud torque can be described as

$${F}_{t} = 2 {L}_{i} {\int }_{0}^{π} \frac{{μ}_{mud} {R}_{pipe}^{2} {Ω}_{i} cos γ d γ}{\sqrt{{R}_{well}^{2} - {( {e}_{i} sin γ )}^{2}} - {e}_{i} cos γ - {R}_{pipe}} and$$

$$T = 2 {L}_{i} {\int }_{0}^{π} \frac{{μ}_{mud} {R}_{pipe}^{3} {Ω}_{i} d γ}{\sqrt{{R}_{well}^{2} - {( {e}_{i} sin γ )}^{2}} - {e}_{i} cos γ - {R}_{pipe}} ,$$

where , Ωᵢ and Lᵢ are pipe angular velocity and length of the i^{th} element. Similarly, the axial viscosity force are described as

$${F}_{t} = - 2 {L}_{i} {\int }_{0}^{π} \frac{{μ}_{mud} {R}_{pipe} {V}_{i \_ Z} d γ}{\sqrt{{R}_{well}^{2} - {( {e}_{i} sin γ )}^{2}} - {e}_{i} cos γ - {R}_{pipe}} ,$$

where V_{i_Z} is pipe axial velocity at i^{th} node.

Mud lateral viscosity forces are calculated using Fₜ=C_{d}LᵢRₚᵢₚₑρ_{mud}V_{i_Lateral}² against the lateral velocity of the drill string, V_{i_lateral}. Empirically derived formulations describing the bit rock may be assumed as DWOB=k_{c}(z−s₀ sin(n_{bit}θ)), where k_{c}, z, s₀, n_{bit}, and θ are rock stiffness, bit penetration in the rock, rock constant, bit cutter row number, and bit angular position, respectively. The following equation to compute downhole rate of penetration (ROP) using downhole weight on bit (DWOB) and top-drive rotation speed in revolutions per minute (RPM): DROP=e₁DWOB\sqrt{ω_{TD}}+e₂, where e₁ and e₂ are rock constants. In one or more embodiments, the downhole ROP equation may be modified to use downhole RPM based on DROP=e₁DWOB\sqrt{DRPM}+e₂.

Average cutting depth may be calculated based on δ_{c}=2πDROP/DRPM. Downhole torque on bit may be calculated based on

$$DTOB = DWOB ( \frac{{OD}_{Bit}}{3} {µ}_{f} + ζ \sqrt{\frac{{OD}_{Bit} {δ}_{c}}{2}} ) + {OD}_{Bit}^{3} {µ}_{mud} DRPM ( {m}_{1} + {m}_{2} {\int }_{t - {T}_{0}}^{t} DROP dt ) ,$$

where ζ, m₁, and m₂, are model parameters, μ_{f} and OD_{Bit} are friction coefficient and bit outer diameter, respectively, and μ_{mud}, is mud viscosity. OD_{Bit}³μ_{mud}DRPMm₁ takes mud viscosity torque into account and OD_{Bit}³μ_{mud}DRPMm₂∫_{t-T}_{₀}^{t}DROP dt calculates the cutting resistive torque on the bit.

Stick-slip is generally considered the most damaging of torsional vibrations and can reduce the service life of downhole and surface equipment. Successive stick-slip oscillations create large cyclic stresses, which lead to fatigue problems. Accordingly, friction mechanism that leads to stick-slip can be added to the model to predict this behavior. The stick phase represents the time duration that the rotational bit speed is zero and static friction dominates the motion. Slip is the interval when the summation of internal and external torques overcomes static friction, where the drill string starts moving and kinetic friction is applied to the system. The updated friction coefficient may be calculated based on

$${μ}_{f} = \frac{- 2 ( {μ}_{s} - {μ}_{k} )}{π ( ( 1 + {τ}_{rock} \vert DRPM \vert ) + {μ}_{k} )} {tan}^{- 1} ( ɛ DRPM ) ,$$

where τ_{rock} and ∈ are bit-rock interaction parameters.

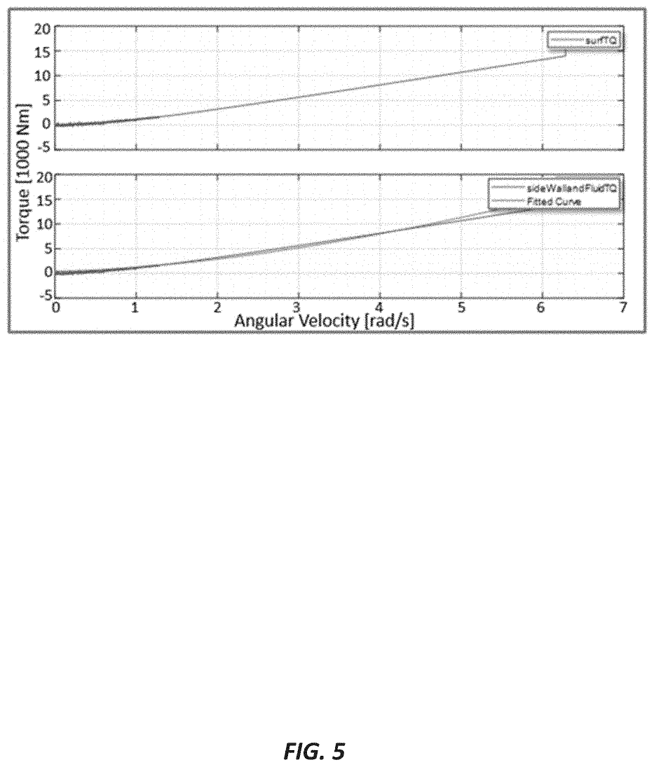

According to certain aspects, the accuracy of the physics model may be increased by using the data model to continuously solve for critical unknowns. The drill string sensors can measure high-speed, high-fidelity torque/velocity curves. The data model calculates Herschel Bulkley fluid model constants by analyzing torque and angular velocity responses of the drill string, as shown in FIG. 5. A combination of surface WOB and surface torque on bit (TOB) parameters weighed against physics model responses and calculated drag forces produce data model calculations of the unknown formation parameters. Important drill string states may be calculated by the data model such as the moment in time when the bit contacts the formation, providing the physics model with an absolute position correction.

Machine learning algorithms may be used to further improve formation change detection and instantaneous bit/formation contact. Historical data archives provide information to study surface sensor trends and signal magnitude/frequency responses. These signal characteristics and others may be extracted through statistical methods—mean, standard deviation, and principle component analysis—before applying classification algorithms such as nearest neighbor or support vector machine.

These algorithms define the dividing boundaries between data that are defined as separate classes. The data model can shift decision boundaries to further adjust the classification predictions as more data is obtained and the classification predictions are validated. A large conditioned data set may be used train the data model and the remaining samples may be used to validate the data model.

In accordance with certain aspects of the present disclosure, outputs from the physics model may be provided at an effectively real-time basis (e.g., <20-50 ms lag time between receipt of sensor data and output from the physics model). Quick adjustments to drilling activity may be made based on this real-time availability of predicted downhole boundary conditions and the effects of these adjustments may be evaluated rapidly.

In one or more embodiments, outputs from the physics model can be compared to sensor data and results of this comparison may be used to adjust the physics mode. For example, the calculated outputs of the physics model generally describe downhole boundary conditions. Primary boundary conditions are generally described by the sensor data. The downhole boundary conditions are related to the primary boundary conditions and this relationship can be used as a validation check as to the accuracy of the physics model. For example, the downhole weight on bit should, taking into consideration drill string weight and other physical factors, correlate to surface weight. If the downhole weight on bit deviates from the surface weight by more than a threshold amount, then adjustments, for example to assumptions made to forces applied to aspects of the physics model, may be made to the physics model to obtain a better correlation between the physics model and sensor data. This tuning of the physics model may be performed, for example, by the data model or by a separate module. As the physics model is continuously being updated by additional sensor data processed by the data model, tuning adjustments to the physics model can be quickly evaluated for effectiveness and validity.

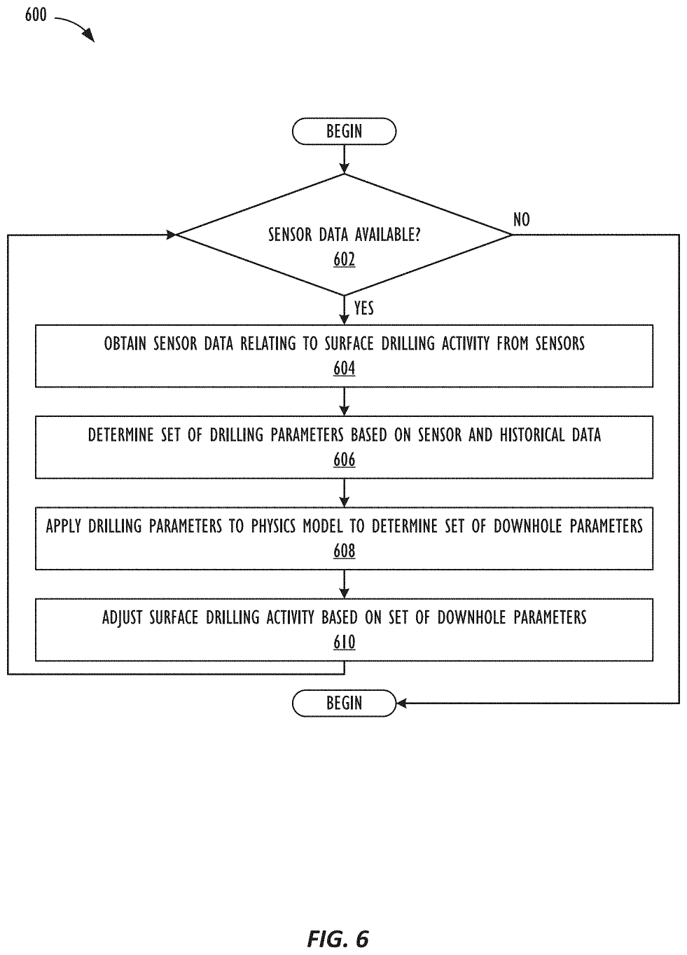

FIG. 6 is a flowchart illustrating a technique 600 for optimizing performance of an automated control system for drilling, in accordance with aspects of the present disclosure. If sensor data from one or more sensors disposed at a drilling site is available at step 602, the sensor data is obtained at step 604. This sensor data describing the surface drilling activity may include, for example, surface mud flow rate, surface torque, surface RPM, and surface weight. At step 606, the sensor data is used by a data model to determine a set of drilling parameters based on a comparison between the sensor data and a set of historical data. This comparison may be based on statistical analysis and/or machine learning algorithms. At step 608, the set of drilling parameters are applied to a physics model of the drilling site to determine a set of downhole parameters for the drilling site. At step 610, the set of downhole parameters are used to adjust activity of one or more drilling tools. Execution then proceeds back to step 602 and the techniques continues so long that sensor data is available from the sensors.

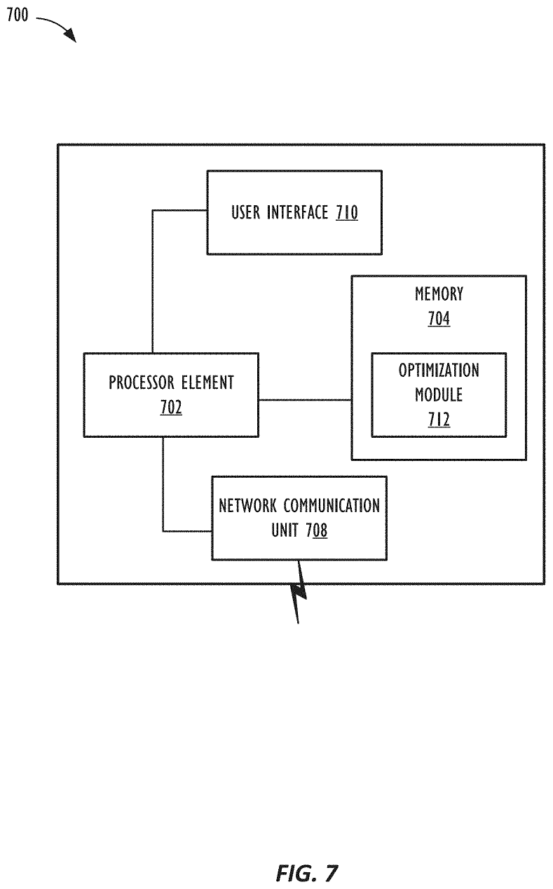

FIG. 7 illustrates a particular computing device 700, that may be more example, a different view of rig computing device 200. Computing device 700 may include a memory 704 that may be operatively coupled to processing element 702. Memory 704 may be a non-transitory medium configured to store various types of data. For example, memory 704 may include one or more memory devices that comprise a non-volatile storage device and/or volatile memory. Volatile memory, such as random access memory (RAM), can be any suitable non-permanent storage device. The non-volatile storage devices can include one or more disk drives, optical drives, solid-state drives (SSDs), tap drives, flash memory, read only memory (ROM), and/or any other type memory designed to maintain data for a duration time after a power loss or shut down operation. In certain instances, the non-volatile storage device may be used to store overflow data if allocated RAM is not large enough to hold all working data. The non-volatile storage device may also be used to store programs that are loaded into the RAM when such programs are selected for execution.

Persons of ordinary skill in the art are aware that software programs may be developed, encoded, and compiled in a variety computing languages for a variety software platforms and/or operating systems and subsequently loaded and executed by processing element 702. In one embodiment, the compiling process of the software program may transform program code written in a programming language to another computer language such that the processing element 702 is able to execute the programming code. For example, the compiling process of the software program may generate an executable program that provides encoded instructions (e.g., machine code instructions) for processor 702 to accomplish specific, non-generic, particular computing functions.

After the compiling process, the encoded instructions may then be loaded as computer executable instructions or process steps to processing element 702 from storage (e.g., memory 704) and/or embedded within the processing element 702 (e.g., cache). Processing element 702 can execute the stored instructions or process steps in order to perform instructions or process steps to transform the computing device into a non-generic, particular, specially programmed machine or apparatus. Stored data, e.g., data stored by a storage device, can be accessed by processing element 702 during the execution of computer executable instructions or process steps to instruct one or more components within the computing device 700.

A user interface 710 can include a display, positional input device (such as a mouse, touchpad, touchscreen, or the like), keyboard, or other forms of user input and output devices. The user interface 710 can be coupled to processor element 702. Other output devices that permit a user to program or otherwise use the computing device can be provided in addition to or as an alternative to network communication unit 708. When the output device is or includes a display, the display can be implemented in various ways, including by a liquid crystal display (LCD) or a cathode-ray tube (CRT) or light emitting diode (LED) display, such as an OLED display. Persons of ordinary skill in the art are aware that the computing device 700 may comprise other components well known in the art, such as sensors, powers sources, and/or analog-to-digital converters, not explicitly shown in FIG. 7.

The programmable devices depicted in FIG. 7 is a schematic illustration of embodiments of programmable devices which may be utilized to implement various embodiments discussed herein. Various components of the programmable devices depicted in FIG. 7 may be combined in a system-on-a-chip (SoC) architecture.

It is to be understood that the various components of the flow diagrams described above, could occur in a different order or even concurrently. It should also be understood that various embodiments of the inventions may include all or just some of the components described above. Thus, the flow diagrams are provided for better understanding of the embodiments, but the specific ordering of the components of the flow diagrams are not intended to be limiting unless otherwise described so.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, tangible, non-transitory memories such as solid-state memories, optical and magnetic disks. Furthermore, it is common in the art to speak of software, in one form or another (e.g., program, procedure, process, application, module, logic, and so on) as taking an action or causing a result. Such expressions are merely a shorthand way of stating that the execution of the software by a processing system causes the processor to perform an action or produce a result.

It is to be understood that the above description is intended to be illustrative, and not restrictive. For example, the above-described embodiments may be used in combination with each other. As another example, the above-described flow diagrams include a series of actions which may not be performed in the particular order depicted in the drawings. Rather, the various actions may occur in a different order, or even simultaneously. Many other embodiments will be apparent to those of skill in the art upon reviewing the above description. The scope of the invention should therefore be determined with reference to the appended claims, along with the full scope of equivalents to which such claims are entitled.

What is claimed is:

1. A method for improving performance of an automated control system for drilling with a drilling system at a drilling site, comprising:
directing drilling tools on a drilling rig to drill, at the drilling site, a borehole using the automated control system;
obtaining, from one or more surface sensors disposed at a surface of the drilling site, surface sensor data relating to surface drilling activity of the drilling system;
determining, based on a comparison between the surface sensor data and a set of historical data, a set of drilling parameters associated with a drilling state;
applying the set of drilling parameters to a physics model of the drilling site to determine a set of downhole parameters for the drilling site, wherein the physics model comprises a simulation of current conditions of the borehole and a drill string of the drilling rig; and
adjusting operation of at least one of the drilling tools based on the set of downhole parameters.

2. The method of claim 1, wherein the set of drilling parameters comprise at least one of an indication that a drill bit is on or off bottom, the drill string is rotating, pipe is being added to the drill string, and an amount of the pipe pushed into the borehole.

3. The method of claim 1, wherein the determination is based on a trained machine learning data model of the drilling site.

4. The method of claim 1, wherein the determination is based on a statistical data model of the drilling site.

5. The method of claim 1, wherein the physics model comprises a finite element method physics model of the drilling site.

6. The method of claim 1, wherein the set of downhole parameters are calculated parameters comprising at least one of a downhole weight on bit, downhole torque on bit, downhole revolutions per minute, and downhole drilled distance.

7. The method of claim 1, further comprising:
receiving an indication that a pipe has been added to or removed from the drill string; and
triggering a recalculation of the physics model based on the indication.

8. The method of claim 1, further comprising:
obtaining an updated surface sensor data relating to surface drilling activity; and
repeating the steps of determining the set of drilling parameters, applying the set of drilling parameters, and adjusting the operation of at least one of the drilling tools based on the updated surface sensor data.

9. The method of claim 1, further comprising:
comparing the set of downhole parameters to the surface sensor data to adjust a configuration of the physics model.

10. The method of claim 1, wherein the steps of obtaining the surface sensor data, determining the set of drilling parameters, applying the set of drilling parameters, and adjusting the operation of at least one of the drilling tools based on the updated surface sensor data are performed at the drilling site.

11. A system for improving performance of an automated control system for drilling with a drilling system at a drilling site, comprising:
one or more drilling tools on a drilling rig to drill, at the drilling site, a borehole using the automated control system;
one or more sensors disposed at a surface of the drilling site; and
the automated control system, wherein the automated control system includes one or more processors and a non-transitory program storage device comprising instructions stored thereon to cause the one or more processors to:
obtain, from the one or more surface sensors disposed at a surface of the drilling site, surface sensor data relating to surface drilling activity of the drilling system;
determine, based on a comparison between the sensor data and a set of historical data, a set of drilling parameters associated with a drilling state;
apply the set of drilling parameters to a physics model of the drilling site to determine a set of downhole parameters for the drilling site, wherein the physics model comprises a simulation of current conditions of the borehole and a drill string of the drilling rig; and
adjust the operation of at least one of the drilling tools based on the set of downhole parameters.

12. The system of claim 11, wherein the set of drilling parameters comprise at least one of an indication that a drill bit is on or off bottom, the drill string is rotating, pipe is being added to the drill string, and an amount of the pipe pushed into the borehole.

13. The system of claim 11, wherein the determination is based on a trained machine learning data model of the drilling site.

14. The system of claim 11, wherein the determination is based on a statistical data model of the drilling site.

15. The system of claim 11, wherein the physics model comprises a finite element method physics model of the drilling site.

16. The system of claim 11, wherein the set of downhole parameters are calculated parameters comprising at least one of a downhole weight on bit, downhole torque on bit, downhole revolutions per minute, and downhole drilled distance.

17. The system of claim 11, wherein the stored instructions further cause one or more processors to:
receive an indication that a pipe has been added to or removed from the drill string; and
trigger a recalculation of the physics model based on the indication.

18. The system of claim 11, wherein the stored instructions further cause one or more processors to:
obtain an updated surface sensor data relating to surface drilling activity; and
repeat the steps of determining the set of drilling parameters, applying the set of drilling parameters, and adjusting the operation of at least one of the drilling tools based on the updated surface sensor data.

19. The non-transitory program storage device of claim 11, wherein the stored instructions further cause one or more processors to:
compare the set of downhole parameters to the surface sensor data to adjust a configuration of the physics model.

20. The system of claim 11, wherein the steps of obtaining the surface sensor data, determining the set of drilling parameters, applying the set of drilling parameters, and adjusting the operation of at least one of the drilling tools based on the updated surface sensor data are performed at the drilling site.

21. A non-transitory program storage device for drilling with a drilling system at a drilling site comprising instructions stored thereon to cause one or more processors to:
direct drilling tools on a drilling rig to drill, at the drilling site, a borehole using the automated control system;
obtain, from one or more surface sensors disposed at a surface of the drilling site, surface sensor data relating to surface drilling activity of the drilling system;
determine, based on a comparison between the surface sensor data and a set of historical data, a set of drilling parameters associated with a drilling state;
apply the set of drilling parameters to a physics model of the drilling site to determine a set of downhole parameters for the drilling site, wherein the physics model comprises a simulation of current conditions of the borehole and a drill string of the drilling rig; and
adjust operation of at least one the drilling tools based on the set of downhole parameters.
